(19) United States
(12) Patent Application Publication
(10) Pub. No.: US 2022/0171951 A1
(43) Pub. Date: Jun. 2, 2022

(54) PRODUCT LABELS, TRUST IDENTIFIER SYSTEMS CONTAINING THE SAME, AND METHODS OF USE THEREOF

(71) Applicant: Avery Dennison Retail Information Services, LLC, Mentor, OH (US)

(72) Inventors: Julie VARGAS, San Antonio, TX (US); Michael KUHNO, Youngsville, NC (US)

(21) Appl. No.: 17/441,724

(22) PCT Filed: Mar. 25, 2020
(86) PCT No.: PCT/US2020/024668

§ 371 Date: Sep. 22, 2021

Related U.S. Application Data
(60) Provisional application No. 62/823,464, filed on Mar. 25, 2019.

(51) Int. Cl. G06K 7/10; G06Q 10/08

(52) U.S. Cl. CPC G06K 7/10445; G06Q 10/087; G06Q 10/0833

(57) ABSTRACT

A distributed ledger-based system and methods for tracking products using the same are described herein. The method ensures authenticity by allowing verification of the digital identity of a physical item at each step of the supply chain. The method may include receiving and verifying integrated circuit chips manufactured by a trusted supplier, assembling the chips into a roll inlay, assembling the inlay rolls into a carton, palletizing the cartons, updating the distributed ledger, e.g., blockchain, with roll, carton, and pallet codes, taking receipt from a specific trusted individual and adding verification to the distributed ledger, e.g., blockchain, and activating a digital identity. GPS information may be associated with every step in order to ensure that the product is properly present at certain manufacturing and encoding locations. Once a digital identity is produced for the product, it may be added to by subsequent use, such as may be desired.

### CROSS REFERENCE TO RELATED APPLICATION(S)

The present application claims priority to and the benefit of United States provisional utility patent application No. 62/823,464 filed Mar. 25, 2019, which is incorporated herein by reference in its entirety.

### FIELD

Product labels, trust identifier systems containing the same, and methods of use thereof, as means for tracking or tracing products.

### BACKGROUND

Businesses can struggle tracing products from their point of origin through the supply chain to the point of sale (POS). This challenge can lead to significant cost expenditures, particularly when a problem is identified with a small number of products that requires the business to issue a recall or freeze sales until all noncomplying products can be removed or repaired.

This is particularly true for food safety. Food safety laws give governmental agencies a great deal of latitude to enforce recalls on certain food products. Likewise, improvements in public health have made it easier to identify the source of a particular outbreak. As a result, the Food and Drug Administration (“FDA”) and the U.S. Department of Agriculture (“USDA”) have recalled food products at ever-increasing rates beginning. These recalls can be significant, often in effect nationwide or across multiples continents. For example, in April 2018, the FDA announced a recall of 206 million eggs over salmonella-contamination concerns, affecting numerous retailers including Walmart and Food Lion. Related recalls involving McDonald's salads and Kellogg's Honey Smacks were issued shortly thereafter. In the summer of 2018, products including Ritz crackers, Goldfish crackers, and Swiss rolls were all recalled in the same week.

Recalls have also been issued in circumstances where it was more difficult to identify the specific source of the outbreak. For example, in 2006, a major E. coli outbreak, spread by contaminated spinach, infected almost 200 people. It took almost two weeks to identify the source (e.g., farm) where the spinach originated, and, during that time, retailers nationwide stopped selling spinach from all sources until the source of the outbreak was identified. The result was a significant loss of revenue for retailers and farmers alike and continued risk to consumers who has purchased contaminated spinach but were unaware of the outbreak or could not identify the source of the spinach they had purchased.

The inability to quickly and accurately identify the source of the contaminated products is likely due to the complicated supply chain which typically involves a network of growers, packing houses, wholesalers, distributors and retailers, almost none of whom had complete information about the supply chain. Electronic data, if it does exist, generally only makes it one or two steps downstream; a retailer might know the identity of their distributor and the distributor might know from which wholesaler or packing house the product was obtained. However, packing houses typically serve several farms and the farm that originally sold the product must be identified manually. With large retail chains selling tens of thousands of products, at thousands of locations, and sourced from thousands of vendors (e.g., Walmart has over 50,000 products on sale at 6,000 locations, sourced from thousands of vendors) tracking products can be a logistical nightmare. As such, even highly sophisticated retailers can take a week or more to identify the origin of a product even under the most urgent of circumstances.

Additionally, as grocery stores and other food providers are increasingly digitizing their shipping, receiving, and inventory management, there are related complexities associated with managing supply chains, store formats, and shopping strategies. At the same time, consumers are demanding more information about their food, particularly origin and sustainability practices, and governments are tightening requirements related to food safety and food waste.

Of course, food is not the only product that may need to be traced to its point of origin. Vehicle manufacturers and operators, such as the automobile and airline industries, use a variety of components manufactured and sold by a variety of vendors. If a vehicle suffers a catastrophic failure, such as a turbine failure in an airplane, it is important to be able to identify the point of origin of the component that failed or was defective so that, if the part failed due to a manufacturing or maintenance defect, other similar components can be identified and repaired or replaced. (This can also be an issue with other types of machine parts, from consumer goods to industrial equipment, though vehicles have a higher risk of catastrophic failure leading to significant loss of life.) Such components can be difficult to identify and source; individual components may not be separately marked with identifying information, and manufacturers of each successive component in a chain (for example, an individual fan blade, the other components of a turbine assembly, an engine, and the aircraft itself may all have different manufacturers) may not have information on the sources of other components in their assembled products. As a result, attribution of fault after an accident can be much more difficult. Likewise, the procedures that must be undertaken in order to ensure the safety of such components are more complex and expensive than they might otherwise be without information sharing.

Finally, it may also be important to parties, other than businesses, where their products come from. Customers may have greater peace of mind if they can confirm that the products they have purchased are not subject to recall anywhere, and have been safely vetted at each stage of the supply chain. This has become an issue of increasing concern for customers due to the high number of counterfeit or poor-quality goods manufactured abroad (e.g., China), which have caused a large number of health scares in the United States. (For example, in one year, toy maker Mattel had to recall nearly one million toys due to lead paint being used in certain Chinese factories, toy train manufacturer Rc2 had to recall 1.5 million toys for the same reason, half a million radial tires were recalled by an American distributor after a safety feature was unilaterally eliminated by the Chinese factory, and—in the scandal that attracted the most news—Spin Master's Aqua Dots products contained a toxic contaminant that hospitalized a number of children.) As such, many customers are clamoring for a way to guarantee that the products they purchase are authentic and free of such unexpected complications.

Customers also have an interest in “ethical sourcing” of products or “sustainable farming or manufacturing techniques” being used in their production. This has resulted in customers having a preference for “ethical” or “sustainable” products which can result a degree of brand loyalty toward companies that can guarantee that they are engaging in sustainable practices and ethical sourcing. Better tracking of products from point of origin to retail can guarantee this for the customer.

One application of distributed ledgers, e.g., blockchain, is product tracking and verification. Distributed ledgers can be used to verify the point of origin for a particular product and can also be used to trace the product throughout its useful live while enabling a clear transfer of ownership to take place at each stage of the product's lifecycle. Anyone with access to a distributed ledger associated with a particular product may be able to identify a point in the product's history indicating where the product came from, who owned it last, and so forth, provided an effective technique for guaranteeing that the distributed ledger is updated at each link of the supply chain.

However, there are limitations to using distributed ledgers in this manner. A distributed ledger is, by necessity, electronic, so if the electronic record cannot be effectively associated with the physical product, it is of limited use. Likewise, if it cannot be guaranteed that the distributed ledger will be updated every time the product changes hands, it is ineffective at establishing an accurate record of the supply chain. There is currently not a manner of properly tracking or tracing a product ID efficiently back to its place of production or the place of origin of a digital identifier.

Therefore, there exists a need for product labels, a trust identifier system, and methods of using thereof to identify and track or trace a product digital ID to its place of production or origin of a digital identifier.

### SUMMARY

Product labels, trust identifier systems containing the same, and methods of use thereof for ensuring that a distributed ledger or distributed ledger record remains associated with the product in question and is accurately updated are described herein.

In some embodiments, a digital product identifier may be utilized to provide product tracking and tracing information. For example, a digital ID may be generated at a place of product origin. Then, using isolated elements of a digital ID, such as portions of a binary serial number, to indicate product information and also distributed ledger or record information, user information, and provider information. In such embodiments the serial number may encoded with such information so as to allow for enhanced tracking and tracing of products and their origins utilizing a distributed ledger or record.

In some embodiments, the labels contain an RFID antenna or inlay, which has been serialized to indicate a specific or designated distributed ledger or source application provider. In other embodiments, the RFID antenna or inlay has been serialized to indicate a specific customer or user and the product information is uploaded to the distributed ledger by a third party, i.e., source application provider. The distributed ledger may be a public or private ledger.

In some embodiments, the labels, systems, and methods are described above, and the serialization is a 38-bit serial number which is used to designate a specific ledger or customer as described above. In some embodiments, a portion of the 38-bit serial number as described above designates or indicates the specific distributed ledger or source application provider. In some embodiment, the portion is a 2-bit portion.

In other embodiments, the labels, systems, and methods are described above, the serialization is a 38-bit serial number, and a portion of the serial number designates or indicates a specific distributed ledger or source application provider and a changing characteristic, such as time period, region or location, program type, supplier, wholesaler, distributor, customer, logistics company, freight carrier, environmental conditions, or combinations thereof. In some embodiments, the portion is a 2-bit portion.

In some embodiments, the labels, systems, methods, and serial numbers are as described above and a 16-bit portion of the 38-bit serial number defines the PCID and the remain 20-bit portion of the 38-bit serial number defines the serial number block.

In still other embodiments, the 38-bit serial number as described above is a portion of a 96-bit electronic product code (EPC) (e.g., SGTIN-96 encoding) additionally containing an 8-bit header, a 3-bit filter, a 3-bit partition, a 24-bit customer prefix, and a 20-bit item reference.

In some embodiments, the label or tag as described above can be read by a variety of different devices including, but not limited to, a hand held scanner, a gate or tunnel, hardware similar to those used for capturing license plate data on automobiles, or combinations thereof.

In some embodiments, the specific or designated distributed ledger is assigned to, owned or controlled by, or affiliated with a specific customer. For example, the specific or designated distributed ledger may be assigned to, owned or controlled by, or affiliated with a luxury goods brand/manufacturer, such as an apparel or footware brand (e.g., Louis Vuitton, Adidas, Nike, etc.). In other embodiments, the luxury goods manufacturer/brand can be a wine or spirits brand, a cosmetics brand, or a jewelry brand. In still other embodiments, the specific customer can be the manufacturer of one or more food products or a farm or ranch that sources fruits and vegetables, meats, or seafood. In other embodiments, the distributed ledger is assigned to, owned or controlled by, or affiliated with specific products or classes of products that may be sold by a variety of retailers. In still other embodiments, specific or distributed ledgers can be created for one or more links in the supply chain (e.g., manufacture, transportation, labor, source, customer experience, etc.) and assigned to, owned or controlled by, or affiliated with one or more distinct or unique customers, users, or providers.

In some embodiments, the trust identifier system as described above is a fork chain system. In some embodiments, the fork chain system includes RFID which can provide a unique identifier that can be mapped to a product, allowing the supply chain to become more efficient, saving time and increasing inventory accuracy. As such, in some embodiments, the fork chain system include an end-to-end system leveraging RFID technology which establishes a unique identifier (e.g., serialized RFID tag or label as described above), verifies the digital identity of a physical item, and associates the digital identifier with the physical item. The system may include additional features directed at ensuring that the data associated with the distributed ledger is trustworthy. Such unique identifiers may be related to specific digital or distributed ledgers, such as Food Trust ledgers and platforms associated with various entities. (It may be contemplated that, when it comes to the maintenance of such a record, the “garbage in, garbage out” principle applies, such that, if the digital identity creation, association, and activation of the physical item—initially or at each successive stage—is not trusted, then the downstream distributed ledger application could be compromised.)

In some embodiments, a “fork chain” system may function to provide a ‘truth” layer to users by combining RFID technology and biometrics. For example, according to one embodiment of a fork chain, a “fork” may have several “prongs” or “tines”, each belonging to a separate chain that may be validated and connected to a particular brand owner chain which may then be connected to a retailer chain. As such, a “fork chain” may be a distributed ledger derivative, where only a small number of people add to a collective ledger; the more limited “fork” may specifically service a particular brand, particular retailer, or other entity as desired.

In some embodiments, the process by which a fork chain system may be implemented may be understood to have at least four steps. In some embodiments, these steps may be subdivided into smaller steps, and may be performed simultaneously or in any order. Any or all steps in the process be performed by the same entity or by different entities.

In a first step, the labels that may be used alongside a trust identifier system, such as a fork chain system, may be manufactured. To manufacture the authenticated labels, the underlying RFID circuits may be manufactured by a trusted supplier, with the trustworthiness of the supplier based on any method as would be understood in the art. As these circuits are assembled, certain records relating to the manufactured circuits may be integrated into a distributed ledger by the chip supplier, including any or all of: the batch identifier (ID) of each of the chips, the wafer ID, the unique tag identification memory associated with and containing data about each chip (which may, in Gen 2 RFID tags, be referred to as a TID), the unique brand identifier associated with the chip supplier, and a variable counter associated with the chip and indicating its position in a production run. Other data may also be stored on the distributed ledger related to the chip, which may be provided along with the chip to the chip recipient from the trusted chip supplier.

Once the chips have been manufactured, and have been delivered from the chip supplier, the chips may then be integrated into label rolls. For example, according to an exemplary embodiment, labels may be manufactured into rolls such that integrated circuit devices are integrated into each label on the roll. As part of this manufacturing process, additional information may be added to the distributed ledger for each RFID tag in each label on the roll. Such additional information may include, for example, a unique roll ID for each roll of labels, an indication of whether the chip or label has been tested as being functional or nonfunctional (“good” or “bad”) or whether the chip or label has been tested as having an acceptable degree of functionality if multiple degrees of functionality are to be contemplated, as well as any other information that may be necessary in order to account for all of the integrated circuit devices used in the manufacturing of the labels. For example, in an exemplary embodiment, chips may be tested prior to their integration with the labels, such that functional chips can be identified and used, and such that nonfunctional chips can be identified and disposed of. According to an exemplary embodiment, each distributed ledger or record associated with each chip may be updated, such that the distributed ledgers or records associated with defective or nonfunctional chips identify those chips as defective or nonfunctional. This may potentially allow the supplier to identify defects, or may allow for variable and dynamic compensation to be provided to the supplier in real time based on the failure rates of their devices, or other such configurations such as may be desired.

According to an exemplary embodiment of a fork chain system, once labels are manufactured in the form of rolls, they may be assembled or loaded into cartons, palletized, and shipped to a customer. According to such an exemplary embodiment, the RFID tags (or other integrated circuit devices, if an alternative is used) may be associated with a roll ID associated with the roll of the RFID tag label, which may be mapped to a particular carton ID based on the carton to which the roll has been added, which may in turn be mapped to a particular pallet ID based on the pallet to which the carton was added. According to an exemplary embodiment, the addition of these values to the distributed ledgers or records associated with each RFID tag may allow information about the RFID tag to be tracked back to the initial chip ID and wafer ID should it be necessary to verify the production process of the chip used by the manufacturer of the labels. This process may likewise be usable in a reverse fashion, such that a roll ID may be associated with a specific set of integrated circuits on the roll, allowing the roll ID to be used in order to identify exactly which chips have been used to form that roll of labels. If, for example, a roll has a particularly high defect rate, this may be identified and traced back to the supplier; it could also conceivably be used if a roll has a particularly low defect rate, which may allow that supplier to be identified and prioritized for future orders, or may allow future specs for suppliers to be updated to match that target.

Once all such identifiers have been associated with the distributed ledgers or records associated with each label, a shipment ID may be created corresponding to a particular shipment. According to an exemplary embodiment, a pallet ID, a case ID, and a roll ID may be mapped with a shipment ID (or “ship to” ID), which may combine the pallet, case, and roll information with shipment information for a particular customer. Alternatively, as previously mentioned, such a procedure may be performed by one actor performing multiple steps, such that, for example, the same company is producing and then using the labels. In such an exemplary embodiment, a shipment ID may instead identify a shipment location, such as a production facility in which the labels will be used.

Once the customer or other recipient has received the labels, the customer may verify receipt of the labels through the distributed ledger(s) or records associated with each label. This may ensure that the production and shipment history of the label is fully traceable from the initial stages of production of the chip to the customer of the label. It may also be contemplated to have situations wherein the labels are only partially completed, or are finished elsewhere, which may also be specified in the production and shipment history of the label. For example, it may be contemplated to have blank labels, intended to be printed upon later or intended to be integrated within a product without any sort of printing being applied, provided to one customer, while in another case it may be desired to have the labels be printed and encoded before shipment. In such cases, wherein the labels may be printed and encoded prior to shipment, additional information such as the electronic product code (EPC) of the RFID may be integrated with the distributed ledger(s) or records at this stage such as may be desired. For example, the EPC may be added to the label distributed ledger(s) or records prior to the label being associated with a roll ID, a case ID, and so forth.

Once the customer (or production facility or other destination) has received the rolls of labels, a second step may start. In an exemplary embodiment of a fork chain system, the location to which the labels were shipped may first be integrated into the distributed ledger(s) or records for each label. According to an exemplary embodiment, such information may be, for example, a GPS location of the facility or a mailing address, or any other identifier such as may be desired. (Alternatively, only a simple identifier such as “Location 1” or “LOC_1,” “LOC_2,” “LOC_3,” and so forth may be added. Location information may generally be referred to as an identifier for “LOC_N,” which may or may not contain detailed information such as GPS information or other absolute coordinate information, address information or other relative location information, and so forth.) According to an exemplary embodiment, it may be contemplated that the customer may have multiple locations in which the pallets of labels may be shipped; according to an exemplary embodiment, if the customer has a variety of end locations to which the labels may be shipped, the shipment of the labels to these locations may be tracked via distributed ledger(s) or records, and each of the customer's locations may host a secure node that may be used to read the product and verify the receipt of the product and the location of receipt.

Once the pallet has reached the end location (identified herein as LOC_N), it may be desired to have a specific employee of the company be responsible for inspecting the labels and updating the distributed ledger(s) or record(s) associated with each label. According to an exemplary embodiment, it may alternatively be contemplated to have a set of authorized employees or agents of the customer or other recipient, or specific devices of the customer (for example, if the customer has an automated receipt process), which may be able to update the distributed ledger(s) or records. In an exemplary embodiment, a distributed ledger or record may be updated to show the identifying information for a particular authorizing employee, which may update the ledger to show, for example, “Received by ______” or “Received—Employee 306. In such an exemplary embodiment, once the case ID, pallet ID, or roll ID is received, one of the identifiers (such as a roll ID) may be transferred to this individual ID for the employee such that the roll ID or other identifier can be tracked via a distributed ledger or record. According to an exemplary embodiment, individual label IDs may also be directly transferred or may be updated directly to include this employee ID information, such as may be desired, or may instead simply inherit it from the roll ID information or other identifying information.

Once this individual receives the assigned or commissioned roll ID, the trust identifier system, e.g., fork chain system, may require authenticating information be added to the distributed ledger or record from this individual. For example, according to an exemplary embodiment, the individual may be provided with a biometric scanner or other biometric information; for example, the individual may enter their thumbprint or retinal scan to receive delivery of the rolls, generating a code with the biometric information and other information such as the date and time of receipt, and such information may be added to the distributed ledger for each label (or may be associated with specific IDs such as the roll IDs) such as may be desired. Other authentication methods other than, or in addition to, biometrics may also be contemplated; for example, in one exemplary embodiment, an individual may provide an encrypted electronic signature to the distributed ledger(s) or record(s). This may ensure that the labels are provided to a specific accountable individual that can verify themselves as an employee through the customer company through whatever authentication measures may be appropriate.

In some embodiments, the next step is trusted application of the label to a particular product at the point of use. According to an exemplary embodiment of a fork chain system, once a specific roll ID ownership value is assigned or transferred to an individual ID, the individual may then encode certain further information on the distributed ledger(s) or record(s), optionally with specific hardware, and optionally after performing certain other actions such as may be desired.

For example, in some embodiments of the trust identifier system, e.g., fork chain system, an individual may first use a dedicated hardware system (or other system) in order to verify the accuracy of each roll ID, as well as any other details stored on the distributed ledger. For example, the same dedicated hardware system may be used in order to perform chip testing, such as may be desired; each RFID tag encoded in each label, or some appropriate selection of RFID tags in the label roll, may be tested in order to ensure that the RFID tags can be properly read.

In some embodiments, a customer hardware system may incorporate a printer, which may be used to print any variable information on the labels that may be desired. In some embodiments, the labels are blank and the printer may be used to print all desired information on the labels. In some embodiments, variable information may be printed on just a portion of the labels in order to supplement unchanging information provided on the labels in the previous step, if the labels were prepared in this manner in the previous step. In some embodiments, the label printer used by the customer may be connected to an encoder or another hardware device configured to record the variable data in the distributed ledger(s) or record(s).

In some embodiments, a customer hardware system may further include an encoder, which may be used to encode information in the RFID tag of the label. In some embodiments, an encoder may be provided before or after the printer, or may be provided concurrently with the printer in that some printer tasks may be performed beforehand or afterward; for example, labels may be printed upon, encoded, and then sliced apart. In some embodiments, the encoded information may be stored in the distributed ledger(s) or records in some form. For example, all of the encoded information may itself be stored in the distributed ledger(s) or records, which may allow for the information to be easily accessed by tracing the product's history. In another exemplary embodiment, only a selection of encoded information, or an indication that the information has been successfully encoded, may be stored in the distributed ledger(s) or record(s).

In some embodiments, a customer hardware system may include a location encoder, which may encode the location at which the label was printed and encoded. In some embodiments, this may be part of the encoder, or may be a separate device. In some embodiments, a location encoder may make a live retrieval of the current location with every encoding (for example, via GPS or other geolocationing technologies) or may encode a predetermined location. For example, the address of the factory may be encoded. In other embodiments, a pre-recorded GPS coordinate or other location indication may be encoded without such location being checked first. For example, the encoded location may be added to the distributed ledger(s) or record(s), along with the other information associated with the RFID label, in such a manner as to tie it to both the roll ID (and/or the individual label ID) and the individual ID of the customer employee.

In some embodiments, it may be contemplated to have a combination printing and encoding machine (or a machine that performs some combination of printing and encoding) which may also be a mobile node on the distributed ledger(s) or record(s). According to an exemplary embodiment, the combination printing and encoding machine may perform the functions of printing, data encoding, and location encoding, after verifying the individual ID and the roll ID to ensure that each was proper.

In some embodiments, it may be contemplated that a customer may be making use of already printed labels (that have not been encoded), already encoded labels (that have not been printed or which do not feature a finalized print), or labels that have already been printed and encoded. In some embodiments, it may be contemplated that printing and encoding may be performed as a part of roll manufacture, if desired. Alternatively, it may be contemplated to have a service bureau or other intermediate company perform the labeling and printing, such as may be desired. In some embodiments, should there be a service bureau performing any intermediate steps, such information may be indicated on the distributed ledger in a similar matter to the method previously discussed. In such an embodiment, the customer may complete the labels as necessary, and may then provide additional location encoding, indicating that the labels have been received in whatever form they have been received in, and indicating that the labels have been modified and added to the products as appropriate.

Once the customer (or, again, other production location, such as may be contemplated) has completed the printing and encoding process, an authorized individual at the customer (who may be, for example, a trusted employee of the manufacturing company) may apply the digital identity to the physical product. It may be contemplated, in one exemplary embodiment of a fork chain system, that the rolls may be fully traceable up until this point, with the rolls being assigned to this employee and validated by the printer and encoder machine node. After this point, the focus may be on the individual labels, as the labels may be applied to the actual physical products with which they will be associated, incorporating such information into the distributed ledger(s) or record(s) associated with each product.

In some embodiments, the next step is or includes a means for properly associating the physical products with the RFID tag and with the distributed ledger record associated with that RFID tag. In some embodiments, this step is or includes a process for incorporating the two. Once a particular physical product is assigned a specific label, or during the manufacturing process, a final time stamp may be applied to the distributed ledger(s) or record(s) associated with the RFID tag of the label, corresponding to the time at which the tagged product was scanned and read during the manufacturing process or a time immediately after labeling. This final timestamp may provide for the traceability of the label all the way back through the label supply chain, to the first production of the integrated circuits.

Once this has occurred, the manufacturer may, upon reading the tagged product and time stamp, create a verification report so as to provide the product with a cohesive digital identity. For example, a verification report may include verification that the labels have come from a trusted source, verification that the commissioned labels have been provided to the correct manufacturing location, verification that the labels have been updated by a trusted employee, verification that the labels have been properly encoded at a defined location, verification that the labels have been applied to a product at a defined location (by geolocation or otherwise) as overseen by the trusted employee, and verification that the product's digital identity has been finalized and activated for downstream supply chain uses.

In some embodiments, once this permanent digital identity has been created, others may be able to add to the distributed ledger(s) or record(s) associated with a particular product. For example, once the product has an activated digital identity, it may be updated with timestamp and location information showing that it has been provided to a retailer, timestamp and location information of an original purchase by a first party, information showing that the first party donated the product to a consignment store or sold it to a reseller (e.g., StockX), information showing that it was purchased from the consignment store by a second party, and so forth. In some cases, a product having a digital identity may be updated other than when it changes hands; for example, in an exemplary embodiment, a digital identity of a product may be updated if it is returned or exchanged (for example, if it is clothing of an improper size), or may even be updated when it is taken to particular places (for example, a user that travels to a foreign country may have their products “check in” in those foreign countries to show where they have been).

In some embodiments, the distributed ledger(s) or record(s) associated with a particular RFID tag in a label may be combined with a pre-existing distributed ledger or record associated with a product, or with any other component of the process. For example, in an exemplary embodiment, a particular product may be designated by a distributed ledger or record associated with the raw materials used to make the product (for example, fabric used to make clothing). Companies providing transportation or providing other labor may also have their own distributed ledger(s) or record(s) indicating what was done when, which may be reconciled with the distributed ledger(s) or record(s) of the RFID tag and of the raw materials.

In some embodiments, the “fork” chain is, in particular, an apparel “fork,” one specific prong of the fork chain ledger may contain apparel trim, tickets, tags, labels, woven components, buttons, zippers, and so forth. Each of these components may be validated/verified with RFID to provide for the integrity of the source. In this same exemplary embodiment, another prong may be the material chain, which may guarantee that fabrics have been sourced from non-conflict regions, made from sustainable materials and/or using sustainable processes, recycled materials, and so forth. Another prong may be a labor prong, where the labor source is validated to be free of child labor, is validated to have safe working conditions, food, shelter, reasonable hours, and so forth. Another prong may be transportation, which may, for example, identify that the carriers have not been implicated in illegal activity, such as illegally flagged vessels or faced charges of bribery or corruption or may identify that the carriers do not (or do, depending on preference) support boycotts against particular countries. (In one exemplary embodiment, the use of the “fork” chain may allow products which involve particular companies somewhere in the supply chain to be marketed in specific locations or to specific target demographics; for example, if it is desired to sell a product in a heavily political area, a shipping company may be selected that has made a high-profile endorsement of a particular politician, and the “fork chain” system may ensure that that shipping information is associated with a specific product to be sold in that area. Meanwhile, in another area, another company could be selected for the contract.)

Other exemplary embodiments of “fork” chains may also be contemplated. For example, it may be contemplated to have a similar system for tracking food rather than tracking apparel. In this case, individual prongs might include a labor prong, a farm prong (identifying that the farm is not one that has been linked to any outbreaks, identifying that the produce is authentically organic, and so forth), a transportation prong, and any other similar prongs such as may be desired.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a structure diagram showing a combined fork chain system.

FIG. 2 is an exemplary embodiment of a process flow diagram for the manufacturing of an RFID-equipped label.

FIG. 3 is an exemplary embodiment of a map showing the geographic location information associated with a fork chain ledger, which may be accessible from a user interface of a user.

FIG. 4 is an exemplary embodiment of a process flow diagram for a fork chain system.

FIG. 5 is an exemplary embodiment of a process flow diagram for a verification system.

FIG. 6 is an exemplary schematic showing the generation of a printed format label and transfer to data hosting services.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

“Distributed ledger”, as used herein, typically refers to a consensus of replicated, shared, and synchronized digital data geographically spread across multiple sites (e.g., nodes), countries, or institutions. Distributed ledges are typically characterized by having no central administrator or centralized data storage. In some embodiments, the distributed ledger includes a peer-to-peer network and consensus algorithms to ensure replication across multiple nodes. Exemplary distributed ledgers include, but are not limited to, blockchain, cryptocurrencies, BigchainDB, IOTA Tangle, Hyperledger, and Hedera.

“Source application provider”, as used herein, refers to the entity or platform that uploads the product information into the distributed ledger.

“Record”, as used herein, means a unit within a distributed ledger, for example a block within a blockchain.

According to an exemplary embodiment, and referring generally to the Figures, various exemplary implementations of product labels, a trust identifier system containing the same, and methods of use thereof are described herein.

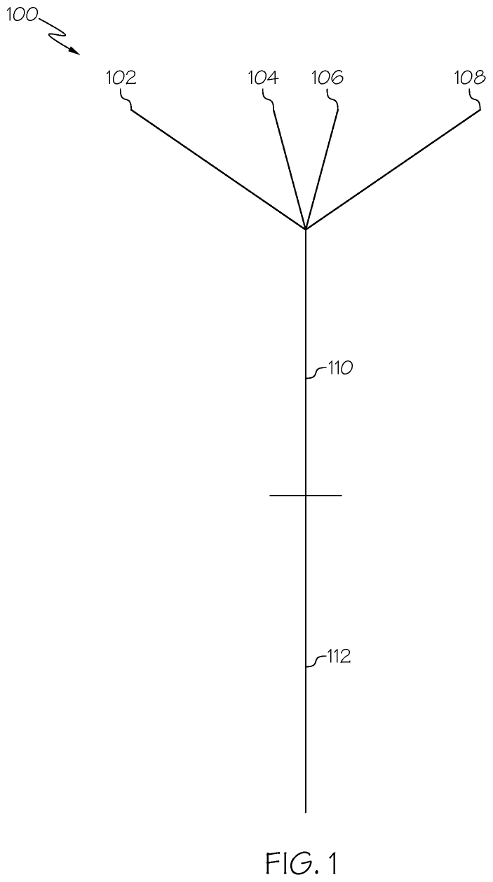

FIG. 1 displays an exemplary embodiment of a structure diagram showing a combined fork chain system 100.

As discussed briefly, in an exemplary embodiment, the distributed ledger(s) or record(s) associated with a particular RFID tag in a label, such as distributed ledger or record 102, may be combined with a pre-existing distributed ledger or record associated with a product, or with any other component of the process. For example, it may be contemplated to have a distributed ledger or record associated with the raw materials used to make the product (for example, fabric used to make clothing) 104, a distributed ledger or record associated with transportation services 106, and a distributed ledger or record associated with manufacturing labor 108. Each of the ledger components may incorporate specific information regarding their history and the locations at which each event in the history occurred; for example, according to an exemplary embodiment, a distributed ledger corresponding to the RFID label of a product 102 may provide the history of the product from initial integrated circuit (IC) manufacturing all the way to its combination with the raw materials used to make the product (in whatever form those materials were in at the time, such as a nearly-finished product) which may be tracked through its own distributed ledger 104 up until the point at which it is combined.

Once the distributed ledger(s) or record(s) are combined, it may be contemplated to add certain other information to the combined distributed ledger as a next step of the fork chain process. For example, according to an exemplary embodiment, branding information 110 may be added to the combined product, after which the product may be distributed to retailers, and retail information 112 may be added to the combined product. (In an exemplary embodiment, this may allow the distributed ledger to be used to such purposes as inventory tracking at the retailer, allowing the retailer to know exactly which products are in stock where and allowing the retailer to know how long these products have been in stock. This may also, for example, allow feedback regarding retailer activities to be easily passed back up the chain to any other interested parties; a manufacturer or distributor may be able to easily determine, from tracking all of the products having distributed ledgers that they have been associated with, which products are selling well and which are not, or which are most likely to be returned, resold, donated, etc. This may also allow for new types of business activity on the part of the manufacturer, distributor, or retailer; for example, a luxury brand of clothing may sell a limited run of designer clothing for an extremely inexpensive price with the caveat that the clothing cannot be sold or transferred, and may make use of the combined ledger system in order to determine if any future transfers are made.

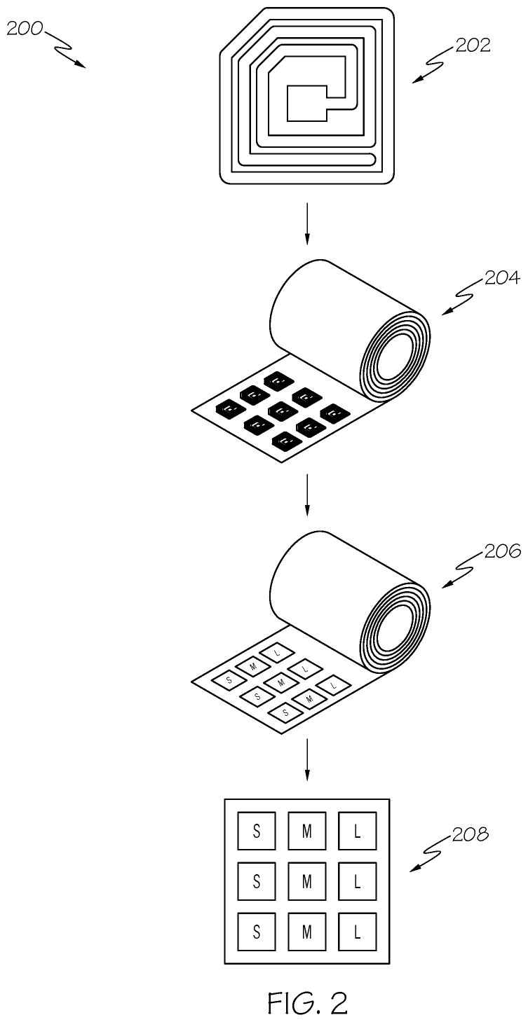

Looking next at exemplary FIG. 2, FIG. 2 provides an exemplary embodiment of a process flow diagram for the manufacturing of an RFID-equipped label 200.

In a first step of a process flow diagram 200, an IC chip may be produced 202. According to an exemplary embodiment, the IC chip may be assigned particular information, such as a secure chip ID, branding information, and TID information, all of which may, in an exemplary embodiment, be associated with timestamp and location information. The IC chip may then be shipped, which may add a shipping event to a distributed ledger or may update an associated shipping ledger, such as may be desired.

In a next step 204, the IC chips may be incorporated into an inlay. It may be contemplated that, during this process, not all of the received IC chips may successfully be incorporated into the inlay; for example, it may be contemplated that some of the received IC chips may be defective, and may be contemplated that some of the IC chips may not be used (or even may be lost/undelivered). According to an exemplary embodiment, the shipping events of the ledger may be updated to show which IC chips have been received, waste chip ledgers may be updated in order to show the defects, and other ledgers may be updated as appropriate.

In a next step 206, labels may be produced from the inlay. (According to an exemplary embodiment, labels may be printed on and/or cut at this stage; in an exemplary embodiment, further finishing or cutting steps may be performed at a later part of the process, such as may be desired.) According to an exemplary embodiment, some of the labels may be identified as being unreadable or defective even after passing the previous stage, and such labels may be identified and removed as appropriate, with the distributed ledger(s) corresponding to those labels being updated.

In a next step 208, the labels may be provided to a customer in some form and finalized. For example, according to an exemplary embodiment, the labels may be provided in a blank or partially printed form, and the customer may perform additional printing to finalize the labels. In such an exemplary embodiment, the customer may print and encode each of their received labels, also encoding location information such as is appropriate.

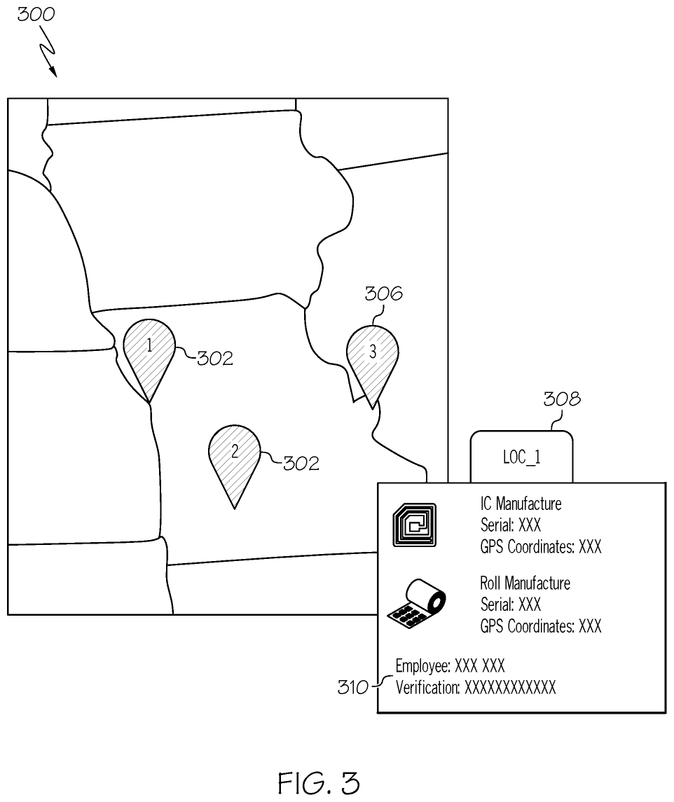

Turning now to exemplary FIG. 3, FIG. 3 shows an exemplary embodiment of a map showing the geographic location information associated with a distributed ledger 300, such as a fork chain ledge, which may be accessible from a user interface of a user. According to an exemplary embodiment, each location in which the product or a portion of the product has been manufactured, sold, or distributed may be indicated as part of the distributed ledger, and a user may be able to display this information as part of a map.

For example, the map featured in FIG. 3 may show a product which has been (for the sake of convenience) manufactured and distributed within the state of Missouri. The map may track the path of the product and its predecessor raw materials through three different locations, marked as “1,” “2,” and “3” on the map, in this case corresponding roughly to Kansas City, Springfield, and St. Louis, and corresponding to reference numerals 302, 304, and 306 respectively.

A summary 308 of the activity grouped under location 1 may be provided as part of the mapping interface, and in this case may be shown in the bottom right corner of the map. According to an exemplary embodiment, the distributed ledger, e.g., fork chain ledger, associated with a particular product may indicate that certain manufacturing for the label was performed in location 1 302, in this case, a company based in location 1 performed manufacturing of an RFID chip, and manufactured the inlay in which these chips were disposed. The verification of a particular employee 310 is associated with this data. Each of the other locations shown on the map 304, 306 may also be selectable, and may provide similar information when selected. For example, location 3 306 may be a retail site in which the product ended up.

Such a system may also support product status inquiries during production. For example, after a particular roll or carton has been scanned and associated with GPS coordinates, it may be represented on the map after being added to the distributed ledger, e.g., fork chain ledger, associated with the roll. This may provide an indication to a downstream retailer as to which products are where and in what quantity, if it is desired to make these distributed ledgers publicly accessible before the product changes hands. Upstream manufacturers may also be able to verify which products properly reached their destinations, allowing them to address any issues involving transportation if any should exist.

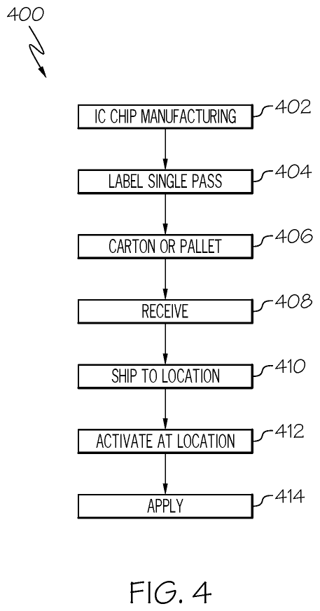

Turning now to exemplary FIG. 4, FIG. 4 displays an exemplary embodiment of a process flow diagram for a fork chain system 400, from an initial manufacturing step for an RFID label 402 to a final step of applying the label to a particular product 414 (after which the product rather than the label may be tracked, such as may be desired).

In a first step, an IC chip may be manufactured 402. This may result in certain information being added to the distributed ledger associated with this specific IC chip, such as a batch ID, a wafer ID, a TID (and any other identification information), an intended shipping destination, and a chip counter indicating the chip's position in a production run, such as may be desired.

Specifically, in an exemplary embodiment of this manufacturing process 402, a set of wafers may be produced with a unique TID and a unique brand ID (or BID) on the die. Each wafer may also have a unique wafer ID associated therewith, along with any other identifying information that may be appropriate. Such identifying information may be provided as unalterable data in the chip.

In a next step 404, a label roll may be initially prepared, for example by integrating the IC chips produced in the previous stage into an inlay. According to an exemplary embodiment, this roll may be updated to provide a roll ID as well as a TID/BID of chips within the roll, as well as mapping information, such as may be desired.

Specifically, in such a step, the TID of the chips used in manufacturing the roll may be tracked and recorded, and waste material may be contained. Bad product may be identified through an appropriate testing method, and defective products may be eliminated; the chips in question may be crushed. Each roll may thus be provided with a unique ID and an association with all known good labels in the roll. This may be provided in a roll distributed ledger, which may contain the TID/BID of the labels. Likewise, in an exemplary embodiment, a waste distributed ledger may be created in order to keep track of all of the chips that needed to be discarded or otherwise went unused.

In a next step, the rolls may be assembled into a carton or pallet 406. In this step, the roll IDs of the rolls in the distributed roll ledger may be associated with the carton ID and stored within a distributed carton ledger (along with a GPS location), and the carton ID may then be stored in a distributed pallet ledger along with a pallet ID, a customer ID, and a supplier ID, along with any other information such as may be desired.

In a next step 408, the pallet, once shipped, may be received. This receipt may be stored in a distributed receipt ledger. This ledger may store a data and time of receipt, a received pallet ID, a carton ID for each carton on the pallet, a GPS location or other location information, as well as a supplier ID indicating the point of origin. As such, once the customer receives the pallet or carton, the system may log the GPS location of the site of receipt or other location information in order to tie it to a receipt log.

In a next step 410, a distributed shipment ledger may also be created, identifying how the pallet has been shipped for consumption by the customer after having been received. (In an exemplary embodiment, it may be contemplated to have this step provided as part of an initial shipment phase, such that, rather than having the customer receive all pallets at a single location, multiple pallets may be shipped to multiple different sites for the same customer, if desired.) According to an exemplary embodiment, a distributed shipment ledger may include a pallet ID, a case ID, a location ID (which may be GPS information if desired) or any other identification information such as may be desired.

In a next step 412, once all of the pallets are at the proper location they may be activated at the location, and may then be applied 414. According to an exemplary embodiment, upon receipt at an application location, the location may receive the pallet and scan the shipment, causing a GPS location to be captured.

In an exemplary embodiment, the application step 414 for the label may include steps of printing, encoding, and application. In a printing step and then an encoding step, or a printing and encoding step if both are to be performed by the same device, a printer may be activated and may be tasked with printing label material on a roll. The labels may then be encoded. As part of this process, the roll ID for each of the label rolls that may be fed into the printer may be scanned, and each of the TIDs of the individual labels may be read, so that each can be validated. The printer may then encode a GPS location (or other location information) when encoding the RFID in the label, along with a printer ID, which may be added to a distributed printer ledger or distributed label ledger such as may be desired. (For example, according to an exemplary embodiment, a distributed printer ledger may include a printer ID, a roll ID, the TID/BID of each label associated with the roll that passes through the printer, a counter value for number of labels that pass through the printer, a GPS location, an encoded EPC, and any other variable data that may be desired.

In a final application step, a label may be applied and associated with a particular product. According to an exemplary embodiment, activation may be manual, such that the label may be read by a trusted employee after being applied or may even be hand-applied by the trusted employee. The employee may read and scan the label, adding a verification to a distributed ledger associated with the label, in order to properly activate it. Subsequent updates to the location of the product may then be added to the distributed based on later access.

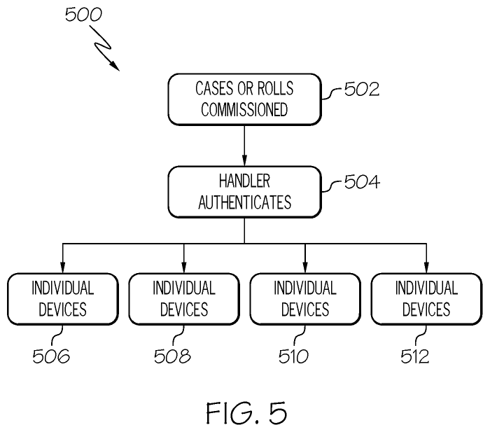

Turning now to exemplary FIG. 5, FIG. 5 is an exemplary embodiment of a process flow diagram for a verification system 500. According to an exemplary embodiment, once the cases or rolls have been commissioned 502, they may be authenticated by a handler 504, through some method of authentication or through multi-factor authentication. For example, according to an exemplary embodiment, biometric authentication may be used, a password may be used, a physical authentication device may be used, or any other authentication may be used as appropriate. GPS information may also be associated with an authenticated product. This information may then be read by individual devices further on down the chain 506, 508, 510, 512, such as a printer, an automated applicator or a hand application tool, or any other devices which may interact with the product or with the distributed.

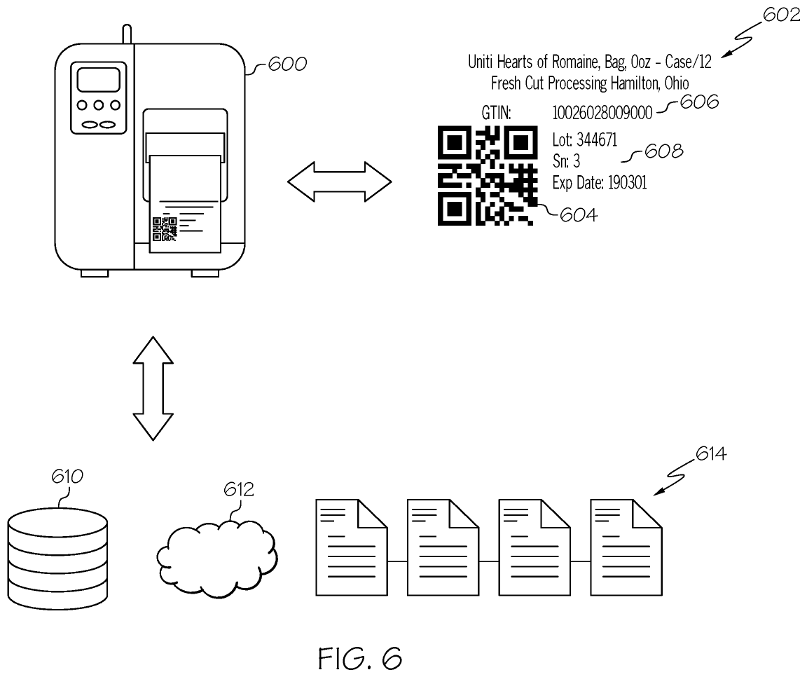

FIG. 6 is a schematic showing a printer 600, such as an ADTP® printer available from Avery Dennison Printer Systems Division of Miamisburg, Ohio, used to generate a visible printed label format 602 which includes for example a QR code 604 and other human readable indicia such as a serial number 606 and other information 608 pertaining to the product being labeled. The printer 600 may also transmit the information to a database 610 which may be resident at the location providing the service or alternatively a remote location or to a cloud based provider 612. The data may then be provided to a distributed ledger, e.g., blockchain or source application provider, e.g., Hyperledger or Hedera 614 for further accessing or processing.

Such a process may, as discussed, be used to connect the roll ID for the roll of labels, the tag ID for an individual tag, the GPS locations that the two had been taken through, the authentication key (such as a biometric authentication key) and the timeline of transfer of ownership, in order to allow this information to be used to authentically connect digital identifiers to physical items.

In still further exemplary embodiments, a distributed ledger, such as the Food Trust hyperledger, can be utilized to provide enhanced visibility and traceability of products, such as food products. Such a system can be further enhanced to provide for item level identification in large quantities, for example also using auto-identification data capture (AIDC) technologies.

In order to achieve this, Food Trust ready identifications at a point of manufacturing can be produced and shared. For example, companies such as IBM are utilizing the Food Trust hyperledger and Food Trust ready identifications can be made and shared directly with IBM or other appropriate entities. For example, specific identifiers in the Food Trust data structure could be pre-loaded in order to help drive further adoption of the Food Trust hyperledger and provide for enhanced and stronger data integrity.

In such an exemplary implementation, identifiers (IDs) that are specific to the IBM Food Trust (or some other entity) may be generated. Any IDs that are outside of the range of those associated with the IBM Food Trust could then be easily identified and interrogated.

Next, IDs could be loaded at a point of manufacture. Further, it is possible to associate product details at a desired or easiest point of data capture downstream. For example, an ID can be read at an inbound data capture and then associated once it is processed for shipment. Using such an exemplary implementation, historical data related to the ID can also be maintained.

Next, IBM (or some other entity) can have item level data flow for all new products entering the Food Trust prior to the track and trace scanning process. The enhanced item level data flow can provide for desired stronger data integrity and help drive wider adoption of the Food Trust.

Further, it is envisioned that such a system could be implemented using radio frequency identification (RFID) tags, barcodes, QR codes, including the GS1 Digital Link standard, data matrix codes, or the like. Such a system could maintain Electronic Product Code Information Services (EPCIS) compliance. Further, depending on implementation, for RFID tags, RFID components could be utilized that are entity-specific, such as using on-chip identifiers that are IBM-specific. Such use of specific and related RFID elements can allow for enhanced security as the RFID information may not be accessed by outside sources. In still other exemplary embodiments, unique serialization schemes may be created for specific entities, such as IBM. Such implementations of barcodes, QR codes, data matrix codes, or other printable, two dimensional indicia capable of being scanned, may provide for rapid deployment to further promote adoption of the IBM Food Trust, or similar platforms.

Other exemplary embodiments may include implementing the above-discussed features with respect to other mandates-in-progress, such as, but not limited to, the Walmart Food Trust initiative. Such implementations, for example using either optical barcode, QR code, data matrix, or RFID solutions may be made such that they adhere to the GS1 and EPCIS standards.

In yet another exemplary embodiment, a point of origin on a distributed ledger or a track/trace-based label creation method and system may be utilized. In such exemplary embodiments, it is known that item level digital identities can be commissioned from a variety of sources. For example, a serialization manager can automatically manage unique digital identities across billions of products using a proprietary schema. This schema can be compatible with GS1 and other industry standards, as desired, and may also be interoperable with other digital identity providers. The unique digital identifiers supplied by a serialization manager may be printed on an item, used to encode RFID tags or otherwise associated as a unique ‘digital twin’ for a pre-encoded RFID tag or item, as desired.

Additionally, as adoption expands in track and trace and distributed ledgers, a print and encode process can, and in some exemplary embodiments, should represent an origin point for traceability of a product associated with a digital ID. At point of digital ID creation, a system and method can automatically capture important and valuable data inputs for traceability. These data inputs include, but are not limited to, origin printer ID, date, time, operator, and, with permission, can also capture printer specific data, such as, but not limited to, item description, origin location, expiry information, item characteristics, and other EPCIS data points that may be valuable or important to show provenance, origin and authenticity of an associated product.

Additionally, this product data can be particularly valuable when the next read point of the digital ID is not connected to the original database or data stream of the item. For example, a system and method using printers, print/encoders, bulk encoders, and other such devices can automatically capture and transfer relevant product information to proprietary databases for track and trace, public or private distributed ledgers for reference further downstream. The print or encode process can be automatically captured and transferred from an internet of things (IoT) device to a digital distributed ledger. This can make the machine to machine transfer a more reliable origin capture/block for the data stream.

Thus, in a further exemplary embodiment, an automatic data transfer may be utilized to drive machine to machine transfer of origin data at a point of item level digital identity creation. In other words, at the time a digital ID is created, data may automatically be sent to a digital ledger to provide enhanced product tracking and tracing.

In one exemplary embodiment, a system and method for automatic data transfer for origin data at a point of item level digital identity creation may utilize a variety of components and steps. For example, a tabletop printer, a portable printer or printer/encoder, a bulk encoding system, such as the Avery Dennison RFID tunnel or high definition read chamber, bulk encoding at a point of manufacturing, and a chipset pre-encoding assignment may all be utilized to facilitate the method and system.

In one exemplary method, an automated, predetermined item level serialization with designated schema to identify the distributed ledger and identify the user may be provided. This is exemplified in the following table where a portion of a 38-bit serial number is isolated to identify the distributed ledger, provider, or user. In this particular example, binary ID is shown as an optional implementation. Such use of a portion of the 38-bit serial number for distributed ledger, provider, and/or user identification can provide for ease of implementation with current systems while also providing the desired specific identifier information.

SGTIN-96 Encoding

| | | | Company | Item | Serial |
|---|---|---|---|---|---|
| Header | Filter 1 | Partition | Prefix | Reference | Number |
| 8 bits | 3 bits | 3 bits | 24 bits | 20 bits | 38 bits |

Serial Number 38 Bits

| Fixed IDENTIFIER | Serial Number 36 bits | |
|---|---|---|
| BINARY ID FOR | PCID | Serial Number Block |
| PROVIDER | 16 bits 4 hex | 20 bits 5 hex |
| 00: Blockchain 1 | | |
| 01: Blockchain 2 | | |
| 10: Blockchain 3 | | |
| 11: Blockchain 4 | | |
| 01 binary | 1111111111111111 | 11111111111111111111 |
| | binary | binary |
| | 65,535 ID's | 1,048,575 Labels per |
| | available | unique UPC and PCID** |
| | FFFF hex | FFFFF hex |

In another exemplary embodiment, a method using a rotating serialization string with an identifier code encryption may be utilized. The rotating serialization and encryption may be based on a variety of factors including, but not limited to, period of time, program type, and/or supplier, where a value can then be used to identify the distributed ledger, user, and/or provider.

In this example, and as shown in the below table, a portion of a 38-bit serial number may again be isolated. The isolated portion of the 38-bit serial number may be used to identify the distributed ledger, provider, and/or user. However, in this exemplary embodiment, specific changing characteristics may also be utilized to enhance security of the system. The changing characteristics include, but are not limited to, time period, region, program type, supplier, and the like. Similar to the above, this example also uses a binary ID number.

SGTIN-96 Encoding

| | | | Company | Item | Serial |
|---|---|---|---|---|---|
| Header | Filter 1 | Partition | Prefix | Reference | Number |
| 8 bits | 3 bits | 3 bits | 24 bits | 20 bits | 38 bits |

Serial Number 38 Bits

| Fixed IDENTIFIER | Serial Number 36 bits | |
|---|---|---|
| BINARY ID FOR PROVIDER | PCID | Serial Number Block |
| 00: Blockchain 1 Date Range 1 | 16 bits 4 hex | 20 bits 5 hex |
| 01: Blockchain 1 Date Range 2 | | |
| 10: Blockchain 1 Date Range 3 | | |
| 11: Blockchain 1 Date Range 4 | | |
| 01 binary | 1111111111111111 | 11111111111111111111 |
| | binary | binary |
| | 65,535 ID's available | 1,048,575 Labels per unique |
| | | UPC and PCID** |
| | FFFF hex | FFFFF hex |

In another exemplary embodiment, a method using a license plate identifier with corresponding item information capture capabilities may be utilized. In this example, hardware similar to that used for capturing license plate data on automobiles may be utilized to identify the distributed ledger, user, and/or provider. An example of this is shown in the below table.

SGTIN-96 Encoding

| | | | Company | Item | |
|---|---|---|---|---|---|
| Header | Filter 1 | Partition | Prefix | Reference | Serial Number |
| 8 bits | 3 bits | 3 bits | 24 bits | 20 bits | 38 bits |

License Plate Serial Number
38 bits or variant with assigned chip ID or brand ID function

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

1. A method of implementing a trust identifier system to track a product, the method comprising:
providing a radio frequency identification (RFID) label or tag, wherein the label or tag is serialized to indicate a specific distributed ledger and/or source application provider;
applying the RFID label or tag to the product; and
associating the product with the distributed ledger and/or source provider.

2. A method for authenticating a product, the method comprising
providing a radio frequency identification (RFID) label or tag, wherein the label or tag is serialized to indicate a specific distributed ledger and/or source application provider;
applying the RFID label or tag to the product; and
associating the product with the distributed ledger and/or source provider.

3. A method for tracking a product through a supply chain, the method comprising
providing a radio frequency identification (RFID) label or tag, wherein the label or tag is serialized to indicate a specific distributed ledger and/or source application provider;
applying the RFID label or tag to a product; and
associating the product with the distributed ledger and/or source provider.

4. The method of claim 1, wherein the label or tag is serialized with a 38-bit serial number.

5. The method of claim 4, wherein a portion of the 38-bit serial number indicates the specific distributed ledger and/or source provider.

6. The method of claim 5, wherein the portion of the 38-bit serial number is a 2-bit fixed identifier.

7. The method of claim 6, wherein a 16-bit portion of the 38-bit serial number defines the PCID.

8. The method of claim 7, wherein the remaining 20-bit portion defines the serial number block.

9. The method of claim 4, wherein a portion of the 38-bit serial number indicates the specific distributed ledger and/or source provider and a changing characteristic.

10. The method of claim 9, wherein the changing characteristic is selected from the group consisting of time period, region or location, program type, supplier, wholesaler, distributor, customer, logistics company, freight carrier, environmental conditions, and combinations thereof.

11. The method of claim 1, further comprising creating a verification report for the product.

12. The method of claim 11, wherein the verification report comprises at least one of the following confirmations: (a) that the RFID label came from a trusted source; (b) that the RFID label has been provided to a correct location; (c) that the RFID label has been updated by a trusted party; (d) that the RFID label has been properly encoded; (e) that the RFID label has been applied to a product at a defined location; and (f) that the RFID label has been activated.

13. The method of claim 1, further comprising creating a digital identity for the product.

14. The method of claim 13, further comprising updating the digital identity of the product.

15. The method of claim 1, wherein a global position system is used to determine the location of the RFID label or tag.

16. The method of claim 1 wherein the specific distributed ledger or source application provider is associated with a second distributed ledger or source provider.

17. The method of claim 16, wherein the second distributed ledger is associated with one of the following attributes of the product: (a) a raw material; (b) a source of the raw material; (c) a source of labor; and (d) a source of transportation.

18. A trust identifier system for tracking a product comprising:
a radio frequency identification (RFID) label or tag for applying to the product, wherein the label or tag is serialized to indicate a specific distributed ledger and/or source application provider;
a first specific distributed ledger or source application provider associated with the RFID label; and
a digital identity associated with the product.

19. The system of claim 18 further comprising a second specific distributed ledger or source application provider associated with a raw material for the product or a source of a raw material for the product.

20. The system of claim 18 further comprising an additional specific distributed ledger
associated with a labor source for the product.

21. The system of claim 18 further comprising an additional distributed ledger
associated with a transportation source for the product.

22. A radio frequency identification (RFID) label serialized to indicate a specific distributed ledger and/or source application provider.

23. The label of claim 22, wherein the label or tag is serialized with a 38-bit serial number.

24. The label of claim 23, wherein a portion of the 38-bit serial number indicates the specific distributed ledger and/or source provider.

25. The label of claim 23, wherein in a portion of the 38-bit serial number indicates the specific distributed ledger and/or source provider and a changing characteristic.

26. The label of claim 25, wherein the changing characteristic is selected from the group consisting of time period, region or location, program type, supplier, wholesaler, distributor, customer, logistics company, freight carrier, environmental conditions, and combinations thereof.

27. The label of claim 23, wherein the portion of the 38-bit serial number is a 2-bit fixed identifier.

28. The label of claim 27, wherein a 16-bit portion of the 38-bit serial number defines the PCID.

29. The label of claim 28, wherein the remaining 20-bit portion of the 38-bit serial number defines the serial number block.

30. The label of claim 23, wherein the 38-bit serial number comprises a portion of a 96-bit electronic product code (“EPC”).

31. A system as shown and described in claim 1.

32. A method as shown and described in claim 1.

33. An apparatus as shown and described in claim 1.

34. A computer program product as shown and described in claim 1.
